(19) United States
(12) Patent Application Publication
(10) Pub. No.: US 2012/0206490 A1
(43) Pub. Date: Aug. 16, 2012

(54) PRINT DATA CREATING APPARATUS, PRINT DATA CREATING METHOD, AND COMPUTER PROGRAM PRODUCT

(76) Inventor: Satoshi HIKIDA, Kanagawa (JP)

(21) Appl. No.: 13/370,770

(22) Filed: Feb. 10, 2012

(30) Foreign Application Priority Data
Feb. 15, 2011 (JP) 2011-029955
Sep. 30, 2011 (JP) 2011-216703

(51) Int. Cl. G09G 5/00

(52) U.S. Cl. 345/660

(57) ABSTRACT

A print data creating apparatus includes an image displaying unit that displays image data; a display image enlarging and reducing unit that enlarges and reduces a display image displayed on the image displaying unit; a region instruction receiving unit that receives a user's instruction to specify a region on the display image; a marker size changing unit that changes a size of a marker that is a seed used in a region growing method in accordance with an enlargement or reduction ratio of the display image; a region splitting unit that performs region split by using the region growing method in response to the region instruction; a display changing unit that changes display based on a result of the region split; and a print data creating unit that creates print data based on a result of the change by the display changing unit.

### CROSS-REFERENCE TO RELATED APPLICATIONS

The present application claims priority to and incorporates by reference the entire contents of Japanese Patent Application No. 2011-029955 filed in Japan on Feb. 15, 2011 and Japanese Patent Application No. 2011-216703 filed in Japan on Sep. 30, 2011.

### BACKGROUND OF THE INVENTION

1. Field of the Invention

The present invention relates to a print data creating apparatus, a print data creating method, and a computer program product.

2. Description of the Related Art

In production printing (printing performed by a high-speed copy machine for business printing market or intracompany printing market), as a method for creating clear plate data to use clear toner (transparent color toner), a method of specifying a region to put the clear toner by using a region selecting function prepared in Photoshop (Registered Trademark) manufactured by Adobe Systems Incorporated or the like is known.

For example, for the purpose of enabling the production of special effects such as watermarks and glossmarks onto printed documents with ease, Japanese Patent Application Laid-open No. 2007-110692 discloses a method for creating special effects including glossmarks and watermarks for use in rendered documents. The method includes: using an interpreter to determine parameters for a special effect; overlaying the object parameters for the special effect over original objects of a document; flattening object parameters for the special effect and original objects of a document by addressing topmost objects first to produce runs with intent tags; introducing intents or altered colors for use with special effects; collecting runs; and rendering runs with intent tags,.

However, in the conventional method, all a user can do is to check a region after being specified, and there is a problem in which the user has difficulty in finely adjusting the region specification while checking what kind of effect is exerted when the clear toner is put on the region.

Under such circumstances, for the purpose of facilitating creation of clear plate data by enabling a user to check in real time what kind of effect is exerted when clear toner is put on a region and to modify the region to put the clear toner in an interactive manner when the user is to create the clear plate data to use the clear toner, the present applicant has proposed a method for performing region split interactively by using a Watershed method and changing luminance of a part to put the clear toner for display.

The present applicant has also proposed a method for displaying in real time what kind of effect is exerted when the clear toner is put on the region by calculation with use of a reflection model in accordance with changes in conditions such as a position and a color of a light source, a position and a direction of a viewpoint, and reflectance of the toner and for allowing the user to modify the region to put the clear toner in an interactive manner when the user is to create the clear plate data to use the clear toner in production printing.

However, in the proposed method, a part to put the clear toner is specified by setting markers, as initial seeds in region growing represented by the Watershed method, to a part to put the clear toner and a part not to put the clear toner. Since fine seed specification and an overall survey for checking the effect are repeated, positions of the seeds are difficult to be checked, which causes a problem of a poor operating efficiency.

This problem is caused by an operation characteristic in which it is necessary to repeat fine region specification and an overall survey for checking the effect to specify a part to put the clear toner on a printed matter and by a characteristic of the region growing in which markers are used as seeds in the region growing method represented by the Watershed method, using a large seed to specify a large part reduces influences of fine noises on the image, and using a small seed to specify a fine part facilitates fine specification.

Meanwhile, the region growing is a region splitting method of starting with an initial seed, determining a neighboring feature, merging the neighbor in a case where the neighbor satisfies conditions such as having a similar feature to make a one-size larger region, and repeating the steps.

A representative example of the region growing is the Watershed method.

For the details of the Watershed method, refer to Japanese Patent No. 4046920, for example.

Therefore, there is a need for a print data creating apparatus and a print data creating method capable of improving an operating efficiency in an operation of repeating fine seed specification and an overall survey for checking an effect when a marker as a seed in region growing is to be set on a part to put clear toner.

### SUMMARY OF THE INVENTION

According to an embodiment, there is provided a print data creating apparatus that includes a storage unit that holds data; an image inputting unit that inputs print image data in the storage unit; an image displaying unit that displays image data; a display image enlarging and reducing unit that enlarges and reduces a display image displayed on the image displaying unit; a region instruction receiving unit that receives a user's instruction to specify a region on the display image; a marker size changing unit that changes a size of a marker that is a seed used in a region growing method in accordance with an enlargement or reduction ratio of the display image displayed on the image displaying unit; a region splitting unit that performs region split by using the region growing method in response to the region instruction input through the region instruction receiving unit; a display changing unit that changes display based on a result of the region split performed by the region splitting unit; and a print data creating unit that creates print data based on a result of the change by the display changing unit.

According to another embodiment, there is provided a print data creating method performed in a print data creating apparatus that includes a storage unit, an image inputting unit, a display image enlarging and reducing unit, an image displaying unit, a region instruction receiving unit, a marker size changing unit, a region splitting unit, a display changing unit, and a print data creating unit. The method includes inputting, by the image inputting unit, print image data in the storage unit; enlarging or reducing, by the display image enlarging and reducing unit, a display image displayed on the image displaying unit; receiving, by the region instruction receiving unit, a user's instruction to specify a region on the display image; changing, by the marker size changing unit, a size of a marker that is a seed used in a region growing method in accordance with an enlargement or reduction ratio of the display image displayed on the image displaying unit; performing, by the region splitting unit, region split by using the region growing method in response to the region instruction input through the region instruction receiving unit; changing, by the display changing unit, display based on a result of the region split performed by the region splitting unit; and creating, by the print data creating unit, print data based on a result of the change by the display changing unit.

According to still another embodiment, there is provided a computer program product including a non-transitory computer-readable medium including programmed instructions. The instructions, when executed by a computer, cause the computer to execute inputting print image data in a storage unit; enlarging or reducing a display image displayed on an image displaying unit; receiving a user's instruction to specify a region on the display image; changing a size of a marker that is a seed used in a region growing method in accordance with an enlargement or reduction ratio of the display image displayed on the image displaying unit; performing region split by using the region growing method in response to the region instruction; changing display based on a result of the region split; and creating print data based on a result of the change by the changing of the display.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a functional block diagram of an image forming apparatus according to an embodiment of the present invention;

FIG. 2 is a flowchart illustrating a process flow in the image forming apparatus of the present embodiment;

FIG. 3 illustrates an example of an original image;

FIG. 4 illustrates an example of an image in which markers have been specified;

FIG. 5 is an example of an image displayed after region split is performed and after luminance is changed;

FIG. 6 is an example of an enlarged image of a brim part of a hat;

FIG. 7 is an example of an image in which a marker size is automatically changed in accordance with an enlargement/reduction ratio to set markers; and

FIG. 8 is an example of an image displayed after region split is performed by using changed markers.

### DETAILED DESCRIPTION OF THE PREFERRED EMBODIMENTS

Hereinafter, embodiments of the present invention will be described.

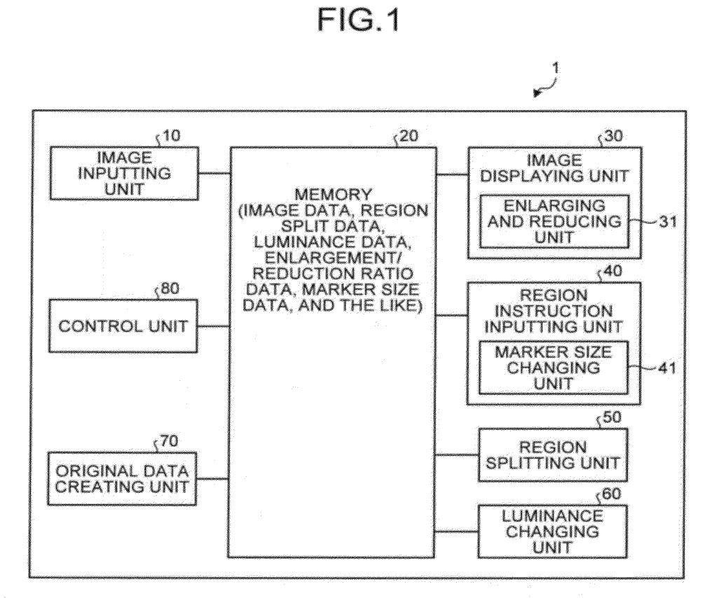

FIG. 1 is a functional block diagram of an image forming apparatus according to the embodiment of the present invention.

An image forming apparatus 1 according to the embodiment illustrated in FIG. 1 includes an image inputting unit 10, a memory (a storage unit) 20, an image displaying unit 30, a region instruction inputting unit 40, a region splitting unit 50, a luminance changing unit 60, an original data creating unit 70, and a control unit 80. The image forming apparatus 1 also includes an enlarging and reducing unit 31 in the image displaying unit 30 and a marker size changing unit 41 in the region instruction inputting unit 40.

The image inputting unit 10 loads print image data in the memory 20 from a file or the like.

The memory 20 holds image data, region split data, luminance data, enlargement/reduction ratio data, marker size data, and the like.

The image displaying unit 30 displays print image data and image data whose luminance is changed after region split. An example of the image displaying unit 30 is a display screen or the like of a personal computer (PC).

The enlarging and reducing unit 31 enlarges and reduces a display image displayed on the image displaying unit 30.

An example of the region instruction receiving unit 40 is a mouse, which receives a user's instruction to specify a part to put clear toner and a part not to put the clear toner on an image. For example, the user clicks the left mouse button to cause a marker of a white circle, as a seed in region growing, to be displayed at a part to put the clear toner on an image displayed on the image displaying unit 30 and clicks the right mouse button to cause a marker of a red circle, as a seed in the region growing method, to be displayed at a part not to put the clear toner.

The marker size changing unit 41 automatically changes the size of a marker, as a seed in the region growing method, in accordance with an enlargement/reduction ratio of an image displayed on the image displaying unit 30. For example, even when a display image is enlarged or reduced in accordance with an equation: (marker size after enlargement or reduction)=(original marker size)/(enlargement/reduction ratio), the marker size changing unit 41 automatically changes the marker size so as not to change the display size of the marker.

The region splitting unit 50 semi-automatically performs region split by using the region growing method in response to instructions of the user. For example, the region split can be performed semi-automatically by growing a region from a marker specified by the user with use of a Watershed algorithm. Meanwhile, the details of the Watershed algorithm are disclosed in Japanese Patent No. 4046920, for example.

The luminance changing unit 60 changes luminance (display) of a part that has been determined to put the clear toner as a result of the region split.

The original data creating unit 70 creates original data to display in real time what kind of effect is exerted when the clear toner is put on the part based on the luminance changing result of the luminance changing unit 60.

Specifically, to change only the luminance without changing a color, the creation of the original data can be achieved by converting an RGB data format into a YCrCb format with respect to the respective pixels of the image data at the part to put the clear toner, changing luminance by calculating the Y component as a luminance component by the following calculating formula:

y=255−(255−y)*r

where y is a luminance value and 0≦y≦255, and r is 0<r<1, an example of which is r=0.5, and reconverting the YCrCb format into the RGB data format. It is to be noted that the original data may be created at the luminance changing unit 60.

The control unit 80 controls the respective functional blocks of the image forming apparatus.

Meanwhile, in the embodiment, although the luminance changing unit 60, which changes luminance of a part that has been determined to put the clear toner as a result of the region split, is taken as an example of a display changing unit, the luminance changing unit 60 is illustrative only. For example, in a case where the apparatus includes a color changing unit, which changes a color, a color of a part that has been determined to put the clear toner may be changed to change the display.

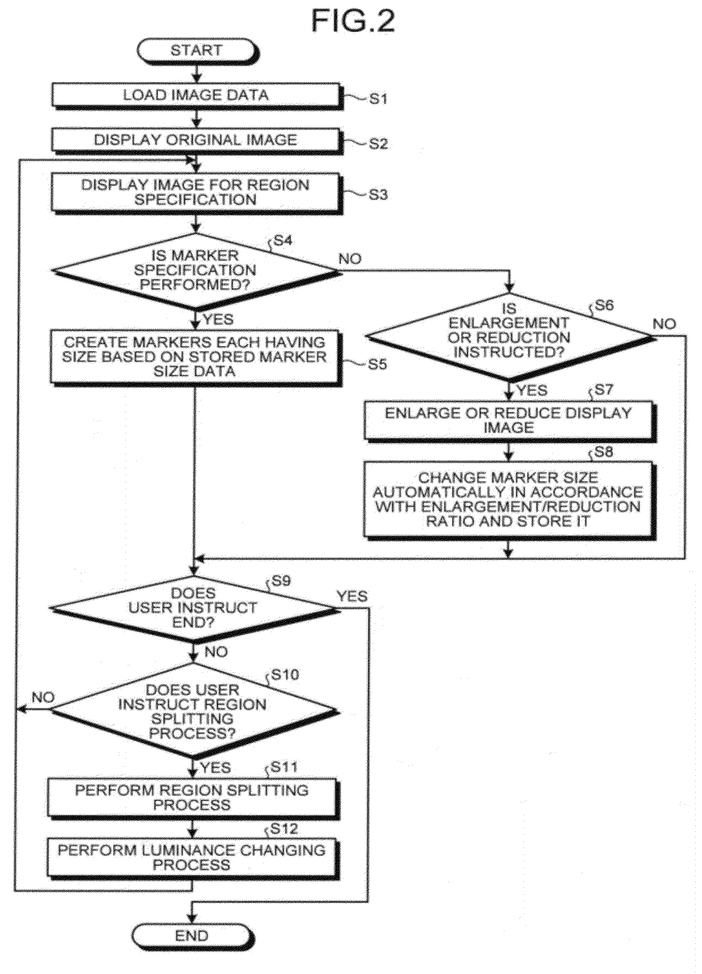

FIG. 2 is a flowchart illustrating a process flow in the image forming apparatus of the embodiment. It is to be noted that the processes described below can be achieved by control of the respective units by the control unit 80.

First, at step S1, the control unit 80 performs control to load print image data in the memory 20 from a file or the like.

Subsequently, at step S2, the control unit 80 performs control to display an original image on the image displaying unit 30 such as a display screen. Subsequently, at step S3, the control unit 80 performs control to display an image used for specifying a region on a different window from a window for the original image.

Subsequently, at step S4, the control unit 80 determines whether or not the user has performed marker specification on the image used for specifying a region. For example, the control unit 80 determines whether or not the user has clicked the left mouse button at a part to put the clear toner and clicked the right mouse button at a part not to put the clear toner. Meanwhile, plural markers can be specified.

In a case where the control unit 80 determines at step S4 that the user has performed the marker specification, the control unit 80 causes markers each having a size based on stored marker size data to be created at step S5. For example, after the control unit 80 performs control to display a white circle marker at a part to put the clear toner and to display a red circle marker at a part not to put the clear toner, the procedure goes to step S9.

On the other hand, in a case where the control unit 80 determines at step S4 that the user has not performed the marker specification, the control unit 80 determines at step S6 whether or not the user has instructed enlargement or reduction of the display image displayed on the image displaying unit 30. For example, the user's turning of the mouse wheel to a far side means an instruction on enlargement while the user's turning of the mouse wheel to a near side means an instruction on reduction.

In a case where the control unit 80 determines at step S6 that the user has instructed enlargement or reduction of the display image displayed on the image displaying unit 30, the control unit 80 performs control to enlarge or reduce the image as much as instructed for display at step S7. Thereafter, at step S8, the control unit 80 causes the marker size to be automatically changed in accordance with an enlargement/reduction ratio and stored. For example, even when the display image is enlarged or reduced in accordance with an equation: (marker size after enlargement or reduction)=(original marker size)/(enlargement/reduction ratio), the control unit 80 causes the marker size to be automatically changed so as not to change a display size of the marker.

In a case where the control unit 80 determines at step S6 that the user has not instructed enlargement or reduction of the display image displayed on the image displaying unit 30, the procedure goes to step S9.

Subsequently, at step S9, the control unit 80 determines whether or not the user has instructed an end. The user's end instruction can be determined based on whether or not the user has performed an operation such as pressing an end button on another control window, for example. In a case where the end is instructed at step S9, the procedure is out of the loop and is ended.

On the other hand, in a case where the control unit 80 determines at step S9 that the user has not instructed the end, the procedure goes to step S10. At step S10, the control unit 80 determines whether or not the user has instructed region split. The user's region split instruction can be performed by pressing a region split button on another control window, for example.

Subsequently, in a case where the control unit 80 determines at step S10 that the user has instructed the region split, the procedure goes to step S11, and the control unit 80 causes the region splitting process to be executed. On the other hand, in a case where the control unit 80 determines at step S10 that the user has not instructed the region split, the procedure returns to step S3.

Subsequently, at step S11, the control unit 80 causes the region split to be semi-automatically performed based on instructions of the user. For example, the region split can be performed semi-automatically by growing a region from a marker instructed by the user with use of a Watershed algorithm.

Meanwhile, as for the “semi-automatic” described herein, the region split with a region instruction input from the user is referred to as “semi-automatic” while the region split without a region instruction input from the user is referred to as “full-automatic.”

Subsequently, at step S12, the control unit 80 causes luminance changing process to be executed. In the luminance changing process, the control unit 80 performs control to change luminance of a part that has been determined to put the clear toner as a result of the region split and to create original data to display in real time what kind of effect is exerted when the clear toner is put on the part.

After the luminance changing process at step S12, the procedure returns to step S3, and the control unit 80 causes the region splitting result to be displayed. The user can modify regions to put the clear toner by further adding markers in an interactive manner while checking in real time what kind of effect is exerted when the clear toner is put on each region.

Meanwhile, in the embodiment, although the case of executing the luminance changing process, in which luminance of a part that has been determined to put the clear toner is changed as a result of the region split, is taken as an example of display changing process, the luminance changing process is illustrative only. For example, color changing process, in which a color of a part that has been determined to put the clear toner is changed, may be executed to change the display.

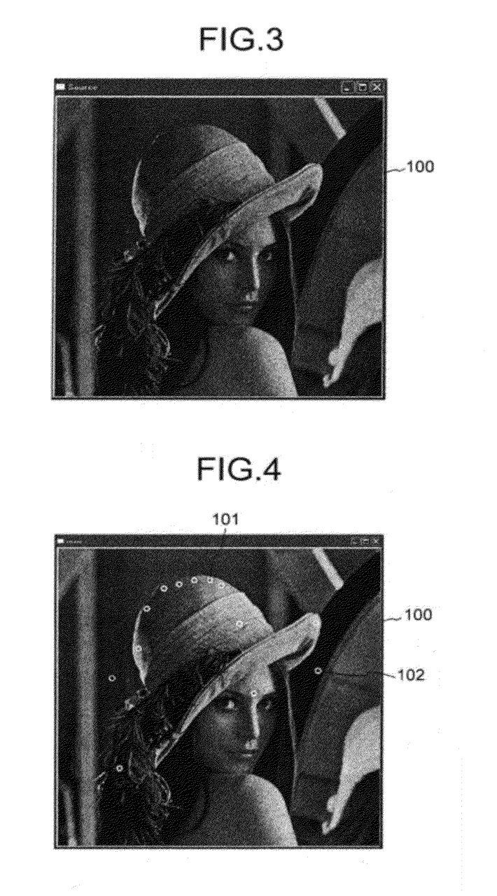

Hereinafter, with reference to FIGS. 3 to 8, a specific case in which regions to put the clear toner are modified in an interactive manner will be described.

FIG. 3 is an example of an original image. FIG. 4 is an example of an image in which markers have been specified. In the image illustrated in FIG. 4, the user specifies ten white circle markers 101 at parts to put the clear toner and three red circle markers 102 at parts not to put the clear toner on an original image 100 illustrated in FIG. 3 with the intention of putting the clear toner at a woman part.

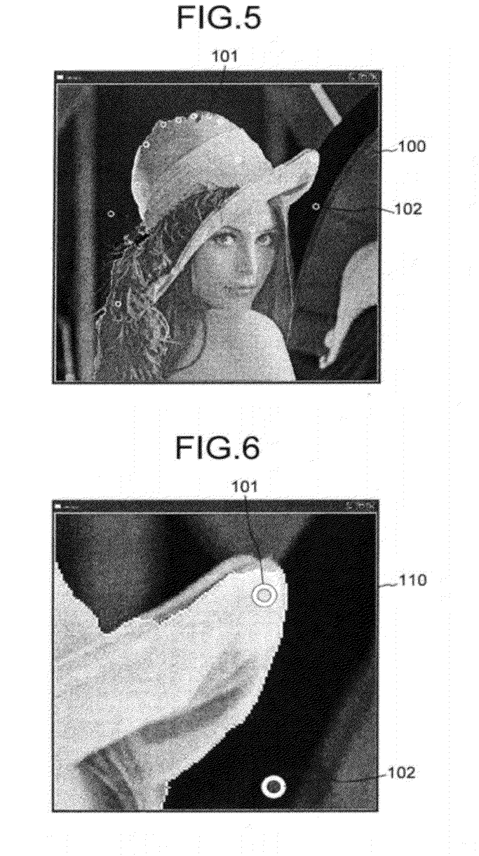

FIG. 5 is an example of an image displayed after the region split is performed and after the luminance is changed, and FIG. 6 is an example of an enlarged image of a brim part of a hat.

As illustrated in FIG. 6, on an enlarged image 110 of the brim part of the hat, markers, as seeds in the region growing method, are enlarged as well when the display image is enlarged, which indicates that it is difficult to specify fine parts in the present state.

Under such circumstances, in the embodiment, the marker size is automatically changed in accordance with an enlargement/reduction ratio to set markers.

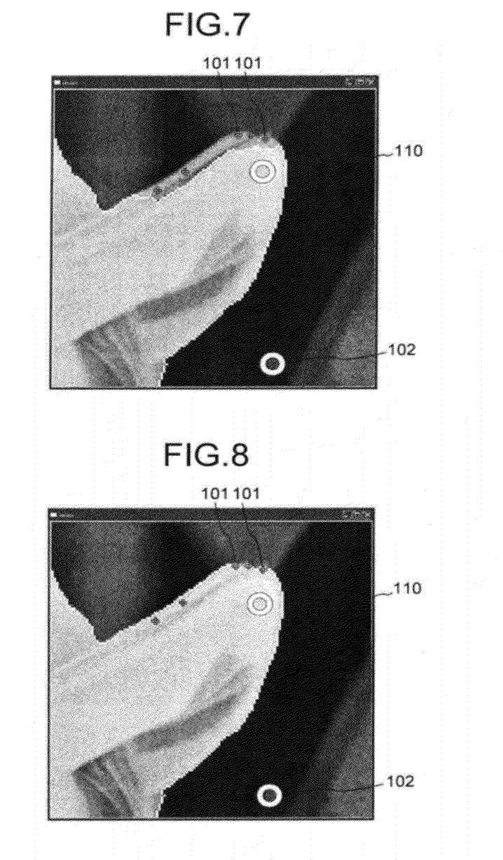

FIG. 7 is an example of an image in which the marker size is automatically changed in accordance with an enlargement/reduction ratio to set markers. In FIG. 7, the size of each marker 101, as a seed in the region growing method, is reduced, which indicates that specification of fine parts is facilitated.

FIG. 8 illustrates an example of an image displayed after region split is performed by using the changed markers. In FIG. 8, since the markers, as seeds in the region growing method, are automatically reduced in accordance with an enlargement/reduction ratio to facilitate specification of fine parts, it is found that the region splitting results at fine parts are improved.

As described above, in the image forming apparatus of the embodiment, in a case where a part to put the clear toner is specified by setting markers to a part to put the clear toner and a part not to put the clear toner, a display image displayed on the image displaying unit 30 can be enlarged or reduced, and the size of each marker is automatically adjusted so as not to be changed largely by enlargement or reduction of the display image. Accordingly, an operating efficiency can be improved in an operation of repeating fine seed specification and an overall survey for checking an effect when a marker as a seed in region growing is to be set on a part to put clear toner.

Meanwhile, the present invention is not limited to the aforementioned embodiment, and the respective functions constituting the image forming apparatus of the aforementioned embodiment can be programmed, and the program can be executed to achieve the object of the present invention.

Also, a recording medium may be any of semiconductor media (e.g., ROM and a non-volatile memory card), optical media (e.g., a DVD, an MO, an MD, and a CD-R), and magnetic media (e.g., a magnetic tape and a flexible disk).

Also, the present invention includes a case in which, based on instructions of a loaded program, an operating system or the like performs part or all of actual processing, and the functions in the aforementioned embodiment are fulfilled by the processing. Further, the present invention includes a case in which the aforementioned program is loaded in memory provided in a function extension board or a function extension unit, and the functions in the aforementioned embodiment are fulfilled by execution of the program.

Also, in a case where the aforementioned program is stored in a storage device of a server computer and is downloaded and distributed to a user's computer connected via a network or is delivered and distributed from the server computer, the storage device of the server computer is included in the recording medium of the present invention.

In this manner, by recording a program having functions of the present invention in a recording medium and distributing the program, the cost, portability, and versatility can be improved.

According to one embodiment, in a case where a part to put clear toner is specified by setting markers, as seeds in region growing, to a part to put the clear toner and a part not to put the clear toner, a display image can be enlarged or reduced, and the size of each marker, as a seed in the region growing method, is automatically adjusted so as not to be changed largely by enlargement or reduction of the display image. Accordingly, an operating efficiency can be improved in an operation of repeating fine seed specification and an overall survey for checking an effect when a marker as a seed in the region growing method is to be set on a part to put the clear toner.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A print data creating apparatus comprising:
a storage unit that holds data;
an image inputting unit that inputs print image data in the storage unit;
an image displaying unit that displays image data;
a display image enlarging and reducing unit that enlarges and reduces a display image displayed on the image displaying unit;
a region instruction receiving unit that receives a user's instruction to specify a region on the display image;
a marker size changing unit that changes a size of a marker that is a seed used in a region growing method in accordance with an enlargement or reduction ratio of the display image displayed on the image displaying unit;
a region splitting unit that performs region split by using the region growing method in response to the region instruction input through the region instruction receiving unit;
a display changing unit that changes display based on a result of the region split performed by the region splitting unit; and
a print data creating unit that creates print data based on a result of the change by the display changing unit.

2. The print data creating apparatus according to claim 1, wherein a Watershed algorithm is used as the region splitting unit.

3. A print data creating method performed in a print data creating apparatus that includes a storage unit, an image inputting unit, a display image enlarging and reducing unit, an image displaying unit, a region instruction receiving unit, a marker size changing unit, a region splitting unit, a display changing unit, and a print data creating unit, the method comprising:
inputting, by the image inputting unit, print image data in the storage unit;
enlarging or reducing, by the display image enlarging and reducing unit, a display image displayed on the image displaying unit;
receiving, by the region instruction receiving unit, a user's instruction to specify a region on the display image;
changing, by the marker size changing unit, a size of a marker that is a seed used in a region growing method in accordance with an enlargement or reduction ratio of the display image displayed on the image displaying unit;
performing, by the region splitting unit, region split by using the region growing method in response to the region instruction input through the region instruction receiving unit;
changing, by the display changing unit, display based on a result of the region split performed by the region splitting unit; and
creating, by the print data creating unit, print data based on a result of the change by the display changing unit.

4. A computer program product comprising a non-transitory computer-readable medium including programmed instructions, wherein the instructions, when executed by a computer, cause the computer to execute:
inputting print image data in a storage unit;
enlarging or reducing a display image displayed on an image displaying unit;
receiving a user's instruction to specify a region on the display image;
changing a size of a marker that is a seed used in a region growing method in accordance with an enlargement or reduction ratio of the display image displayed on the image displaying unit;
performing region split by using the region growing method in response to the region instruction;
changing display based on a result of the region split; and
creating print data based on a result of the change by the changing of the display.
